(19) United States
(12) Patent Application Publication
(10) Pub. No.: US 2007/0227901 A1
(43) Pub. Date: Oct. 4, 2007

(54) Temperature control for ECMP process

(75) Inventors: Yongqi Hu, San Jose, CA (US); Paul D. Butterfield, San Jose, CA (US); Junzi Zhao, Cupertino, CA (US); Stan D. Tsai, Fremont, CA (US); Feng Q. Liu, San Jose, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/394,003

(22) Filed: Mar. 30, 2006

(51) Int. Cl. B23H 9/00; C25D 17/00

(52) U.S. Cl. 205/640; 204/212

(57) ABSTRACT

A method and apparatus for temperature control of an ECMP process is provided. In one embodiment, an apparatus for polishing a substrate is provided. The apparatus includes a platen assembly having a support surface, the platen assembly disposed on a stationary base so that the platen assembly may rotate relative to the base. The apparatus further includes a pad assembly disposed on the support surface of the platen assembly and including an electrode electrically coupled to a power source and an abrasive pad electrically coupled to the power source. The apparatus further includes a control system for heating or cooling the pad assembly.

### BACKGROUND OF THE INVENTION

1. Field of the Invention

Embodiments of the present invention generally relate to a processing apparatus for planarizing or polishing a substrate. More particularly, the invention relates to temperature control for an electrochemical mechanical planarizing (ECMP) process.

2. Description of the Related Art

In the fabrication of integrated circuits and other electronic devices on substrates, multiple layers of conductive, semiconductive, and dielectric materials are deposited on or removed from a feature side, i.e., a deposit receiving surface, of a substrate. As layers of materials are sequentially deposited and removed, the feature side of the substrate may become non-planar and require planarization. Planarization is a procedure where previously deposited material is removed from the feature side of a substrate to form a generally even, planar or level surface. The process is useful in removing undesired surface topography and surface defects, such as rough surfaces, agglomerated materials, crystal lattice damage and scratches. The planarization process is also useful in forming features on a substrate by removing excess deposited material used to fill the features and to provide an even or level surface for subsequent deposition and processing.

Chemical mechanical polishing (CMP) and electrochemical mechanical Planarization (ECMP) are two exemplary processes used to remove materials from the feature side of a substrate. In one exemplary CMP process, a web-type CMP pad containing abrasive particles is adapted to contact the feature side of the substrate using physical abrasion to remove materials. The CMP pad is attached to an apparatus having a rotating platen assembly. The apparatus also has a substrate carrier, such as a polishing head, that is mounted on a carrier assembly above the pad that holds a substrate. The polishing head places the substrate in contact with the pad and is adapted to provide downward pressure, controllably urging the substrate against the pad. The pad is moved relative to the substrate by an external driving force and the polishing head typically moves relative to the moving pad. Typically, the CMP pad includes a plurality of raised portions surrounded by a plurality of depressions. The raised portions of the CMP pad are distributed in a uniform pattern which provides uniform contact to the feature side of the substrate during operation.

The ECMP process typically uses a pad having conductive properties adapted to combine physical abrasion with electrochemical activity that enhances the removal of materials from the feature side of the substrate. The pad is attached to an apparatus having a rotating platen assembly that is adapted to couple the pad to a power source. The apparatus also has a polishing head that is mounted on a carrier assembly above the pad that holds the substrate. The polishing head places the substrate in contact with the pad and is adapted to provide downward pressure, controllably urging the substrate against the pad. The pad is moved relative to the substrate by an external driving force and the polishing head typically moves relative to the moving pad. A chemical composition, such as an electrolyte, is typically provided to the surface of the pad which enhances electrochemical activity between the pad and the substrate. The ECMP apparatus effects abrasive or polishing activity from frictional movement while the electrolyte combined with the conductive properties of the pad selectively removes material from the feature side of the substrate.

Improvements to the ECMP process, i.e., increasing removal rate, improving surface finish, and reducing defects, are constantly sought. However, improvements that are complex may not be desirable since they may substantially increase the cost of the process or cause unintended side effects. Therefore, there exists a need in the art for an improved ECMP process that does not substantially increase the cost of the process or substantially increase side effects.

### SUMMARY OF THE INVENTION

A method and apparatus for temperature control of an ECMP process is provided. In one embodiment, an apparatus for polishing a substrate is provided. The apparatus includes a platen assembly having a support surface, the platen assembly disposed on a stationary base so that the platen assembly may rotate relative to the base. The apparatus further includes a pad assembly disposed on the support surface of the platen assembly and including an electrode electrically coupled to a power source and an abrasive pad electrically coupled to the power source. The apparatus further includes a control system for heating or cooling the pad assembly.

In one aspect of the embodiment, the control system includes a heating element disposed in or proximate to the platen assembly. The heating element may include an infrared lamp disposed in the platen assembly, an infrared lamp attached to the base, or an inductive coil disposed between the pad assembly and the platen assembly. The coil may be substantially spiral shaped or substantially circular, and the system may further include a second substantially circular coil concentrically disposed relative to the coil. The control system may further include a temperature sensor disposed in the platen assembly or a temperature sensor fixed to the base and in visual communication with an upper surface of the pad assembly.

In another aspect of the embodiment, the control system includes an electrolyte tank, a first pump in fluid communication with the electrolyte tank, a heat exchanger having a first chamber and a second chamber, the first chamber in fluid communication with the electrolyte tank and the second chamber in fluid communication with a thermal fluid tank, a second pump in fluid communication with the thermal fluid tank, and a heating element in thermal communication with the thermal fluid tank. The control system may further include a refrigeration unit in thermal communication with the thermal fluid tank. The control system may further include a temperature sensor in thermal communication with an outlet of the first chamber, and a thermostat in electrical communication with the temperature sensor and the heating element.

In another aspect of the embodiment, the control system includes an electrolyte tank, a heating element in thermal communication with the electrolyte tank, and a pump in fluid communication with the electrolyte tank. The control system may further include a refrigeration unit in thermal communication with the electrolyte tank. The system may further include a temperature sensor in thermal communication with the electrolyte tank, and a thermostat in electrical communication with the temperature sensor and the heating element.

In another aspect of the embodiment, the control system includes a fluid channel formed through an upper surface of the platen assembly, and a seal is formed between the electrode and the upper surface of the platen assembly. The control system may further include a thermal fluid tank in fluid communication with the fluid channel, a heating element in thermal communication with the thermal fluid tank, and a pump in fluid communication with the thermal fluid tank and the fluid channel. The control system may further include a refrigeration unit in thermal communication with the thermal fluid tank. The control system may further include a temperature sensor in thermal communication with the thermal fluid tank, and a thermostat in electrical communication with the temperature sensor and the heating element. The fluid passage may be substantially spiral shaped. The platen assembly may be substantially made from a polymer.

In another embodiment, a method for polishing a substrate is provided. The method includes acts of rotating a platen assembly, the platen assembly having a pad assembly disposed thereon, the pad assembly comprising an electrode and an abrasive pad, creating an electrical bias between the electrode and the pad, heating or cooling the pad assembly or an electrolyte fluid, supplying the electrolyte fluid to the pad assembly, rotating the substrate, and lowering the substrate into contact with the pad assembly.

In one aspect of the embodiment, an infrared lamp is disposed in the platen assembly and the act of heating or cooling includes operating the lamp to heat the pad assembly. In another aspect of the embodiment, the platen assembly rotates relative to a base, an infrared lamp is attached to the base, and the act of heating or cooling includes operating the lamp to heat the pad assembly or the electrolyte fluid. In another aspect of the embodiment, an inductive coil is disposed between the electrode and the platen assembly and the act of heating or cooling includes operating the coil to heat the pad assembly. In another aspect of the embodiment, a fluid channel is formed in an upper surface of the platen assembly and the act of heating or cooling includes circulating a heated or cooled thermal fluid through the fluid channel. In another aspect of the embodiment, the act of heating or cooling includes heating or cooling the electrolyte fluid. In another aspect of the embodiment, the act of heating or cooling includes heating the pad assembly or the electrolyte fluid to a temperature of at least 10 degrees Celsius above room temperature.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a plan view of an electrochemical mechanical planarizing (ECMP) system;

FIG. 2A depicts a sectional view of one of the planarizing head assemblies, according to one embodiment of the present invention;

FIG. 2B is a simplified plan view of the platen assembly of FIG. 2A;

FIG. 3 is a diagram for an electrolyte temperature control process, according to another embodiment of the present invention;

FIG. 4A depicts a sectional view of a platen assembly, according to another embodiment of the present invention;

FIG. 4B is a sectional view taken along the line 4B-4B of FIG. 4A; and

FIG. 5 depicts a sectional view of a platen assembly, according to another embodiment of the present invention.

### DETAILED DESCRIPTION

U.S. patent application Ser. No. 11/243,488, filed Oct. 4, 2005, entitled “Conductive Pad Design Modification for Better Wafer-Pad Contact” is hereby incorporated by reference in its entirety.

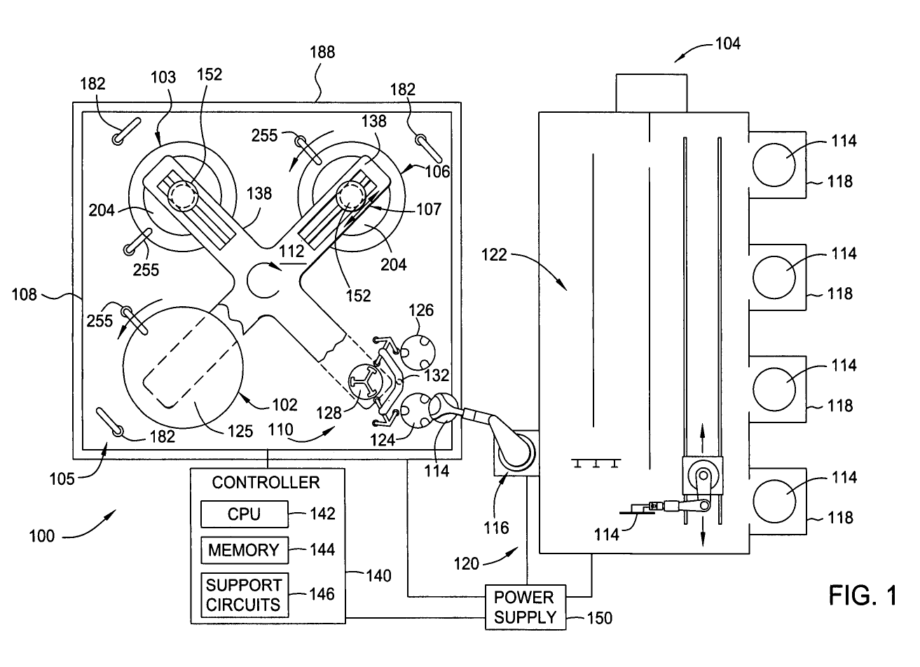

FIG. 1 depicts a processing apparatus 100 having a planarizing module 105 that is suitable for electrochemical mechanical polishing and chemical mechanical polishing. The planarizing module 105 includes at least one electrochemical mechanical planarization (ECMP) station 102, and optionally, at least one conventional chemical mechanical planarization (CMP) station 106 disposed in an environmentally controlled enclosure 188. Examples of planarizing modules 105 that may be adapted to benefit from the invention include MIRRA®, MIRRA MESA™, REFLEXION®, REFLEXION LK®, REFLEXION LK Ecmp™ Chemical Mechanical Planarizing Systems, all available from Applied Materials, Inc. located in Santa Clara, Calif. Other planarizing modules commonly used in the art may also be adapted to benefit from the invention.

For example, in the planarizing module 105 shown in FIG. 1, the apparatus includes a first ECMP station 102, a second ECMP station 103, and one CMP station 106. The stations may be used for processing a substrate surface in three steps. For example, a substrate having feature definitions formed therein and filled with a barrier layer and then a conductive material disposed over the barrier layer may have the conductive material removed in two steps in the two ECMP stations 102, 103, with the barrier layer processed in the conventional CMP station 106 to form a planarized surface on the substrate. Alternatively, the CMP station 106 may be adapted to perform an ECMP process configured to remove the barrier material as well as any residual material. It is to be noted that either of the stations 102, 103, and 106 may also be adapted to deposit a material on a substrate by an electrochemical mechanical plating process (ECMPP), wherein the polarity of the bias provided to the pad is adjusted to deposit material on the substrate.

The exemplary apparatus 100 generally includes a base 108 that supports one or more ECMP stations 102, 103, one or more polishing stations 106, a transfer station 110, conditioning devices 182, and a carousel 112. The transfer station 110 generally facilitates transfer of substrates 114 to and from the apparatus 100 via a loading robot 116. The loading robot 116 typically transfers substrates 114 between the transfer station 110 and a factory interface 120 that may include a cleaning module 122, a metrology device 104 and one or more substrate storage cassettes 118.

Alternatively, the loading robot 116 (or factory interface 120) may transfer substrates to one or more other processing tools (not shown) such as a chemical vapor deposition tool, physical vapor deposition tool, etch tool and the like.

In this exemplary embodiment, the transfer station 110 comprises at least an input buffer station 124, an output buffer station 126, a transfer robot 132, and a load cup assembly 128. The loading robot 116 places the substrate 114 onto the input buffer station 124. The transfer robot 132 has two gripper assemblies, each having pneumatic gripper fingers that hold the substrate 114 by the substrate's edge. The transfer robot 132 lifts the substrate 114 from the input buffer station 124 and rotates the gripper and substrate 114 to position the substrate 114 over the load cup assembly 128, then places the substrate 114 down onto the load cup assembly 128. An example of a transfer station that may be used is described in U.S. Pat. No. 6,156,124, which issued Dec. 5, 2000, entitled “Wafer Transfer Station for a Chemical Mechanical Polisher,” which is incorporated herein by reference to the extent it is not inconsistent with this disclosure.

The carousel 112 generally supports a plurality of planarizing or carrier heads 204, each of which retains one substrate 114 during processing. The carousel 112 articulates the carrier heads 204 between the transfer station 110, the one or more ECMP stations 102, 103 and the one or more polishing stations 106. One carousel that may be adapted to benefit from the invention is generally described in U.S. Pat. No. 5,804,507, issued Sep. 8, 1998, entitled “Radially Oscillating Carousel Processing System for Chemical Mechanical Polishing,” which is hereby incorporated by reference to the extent the application is not inconsistent with this disclosure.

Generally, the carousel 112 is centrally disposed on the base 108. The carousel 112 typically includes a plurality of arms 138. Each arm 138 generally supports one of the planarizing or carrier heads 204. Two of the arms 138 depicted in FIG. 1 are shown in phantom so that the transfer station 110 and the planarizing surface 125 of ECMP station 102 may be seen. The carousel 112 is indexable such that the carrier head 204 may be moved between the stations 102, 103, 106 and the transfer station 110 in a sequence defined by the user.

Generally the carrier head 204 retains the substrate 114 while the substrate 114 is disposed in the ECMP stations 102, 103 or polishing station 106. The arrangement of the ECMP stations 102, 103 and polishing stations 106 on the apparatus 100 allow for the substrate 114 to be sequentially processed by moving the substrate between stations while being retained in the same carrier head 204.

To facilitate control of the polishing apparatus 100 and processes performed thereon, a controller 140 comprising a central processing unit (CPU) 142, memory 144, and support circuits 146, is connected to the polishing apparatus 100. The CPU 142 may be one of any form of computer processor that can be used in an industrial setting for controlling various drives and pressures. The memory 144 is connected to the CPU 142. The memory 144, or computer-readable medium, may be one or more of readily available memory such as random access memory (RAM), read only memory (ROM), floppy disk, hard disk, or any other form of digital storage, local or remote. The support circuits 146 are connected to the CPU 142 for supporting the processor in a conventional manner. These circuits include cache, power supplies, clock circuits, input/output circuitry, subsystems, and the like.

Power to operate the polishing apparatus 100 and/or the controller 140 is provided by a power supply 150. Illustratively, the power supply 150 is shown connected to multiple components of the processing apparatus 100, including the transfer station 110, the factory interface 120, the loading robot 116 and the controller 140. In other embodiments separate power supplies are provided for two or more components of the polishing apparatus 100.

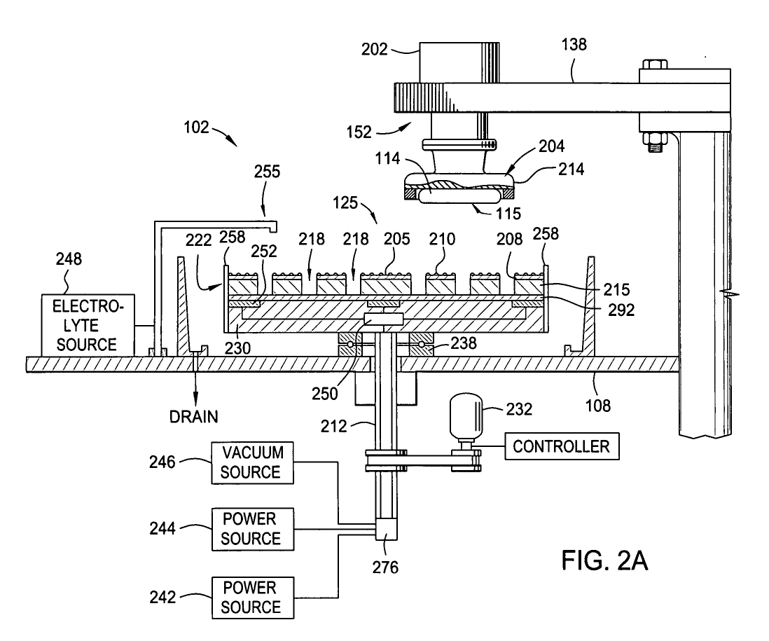

FIG. 2 depicts a sectional view of one of the planarizing head assemblies 152, according to one embodiment of the present invention. The planarizing head assembly 152 generally comprises a drive system 202 coupled to a carrier head 204. The drive system 202 generally provides at least rotational motion to the carrier head 204. The carrier head 204 additionally may be actuated toward the ECMP station 102 such that the substrate 114, retained in the carrier head 204, may be disposed against a contact surface 125 of the ECMP station 102 during processing. The head assembly 152 may also translate movement in a path indicated by arrow 107 in FIG. 1 during processing. The drive system 202 is coupled to the controller 140 (in FIG. 1) that provides a signal to the drive system 202 for controlling the rotational speed and direction of the carrier head 204.

In one embodiment, the carrier head 204 may be a TITAN HEAD™ or TITAN PROFILER™ wafer carrier manufactured by Applied Materials, Inc. Generally, the carrier head 204 comprises a housing 214 and a retaining ring that defines a center recess in which the substrate 114 is retained. The retaining ring may circumscribe the substrate 114 disposed within the carrier head 204 to prevent the substrate 114 from slipping out from under the carrier head 204 during processing. The retaining ring can be made of plastic materials such as PPS, PEEK, and the like, or conductive materials such as stainless steel, Cu, Au, Pd, and the like, or some combination thereof. It is further contemplated that a conductive retaining ring may be electrically biased to control the electric field during the ECMP process or an electrochemical plating process. It is also contemplated that other planarizing or carrier heads may be utilized.

The ECMP station 102 generally includes a platen assembly 230 that is rotationally disposed on the base 108. The platen assembly 230 is supported above the base 108 by a bearing 238 so that the platen assembly 230 may be rotated relative to the base 108. An area of the base 108 circumscribed by the bearing 238 is open and provides a conduit for the electrical, mechanical, pneumatic, control signals and connections communicating with the platen assembly 230.

The ECMP station 102 includes a pad assembly 222 coupled to an upper surface of the platen assembly 230. The pad assembly 222 depicted in FIG. 2 includes a first conductive layer, such as a contact layer 208 comprising the upper surface of the pad assembly 222, an article support layer or subpad 215, and a second conductive layer, such as the electrode 292. In one embodiment, the contact layer 208 has a contact surface 125 that is adapted to contact the feature side 115 of the substrate 114 during processing. In another embodiment, the contact layer 208 may be further coated with a metallic coating that is adapted to at least partially contact the feature side 115 of the substrate 114. In another embodiment, the contact layer 208 is adapted to contact the feature side 115 of the substrate 114 and the contact layer 208 may be at least partially coated with the metallic coating and a portion of the contact layer 208 is exposed. In another embodiment, the contact layer 208 may be at least partially coated with the metallic coating and at least a portion of the coating is adapted to be consumed by the process to expose at least a portion of the contact layer 208. Alternatively or additionally, at least one or both of the contact layer 208 and the metallic coating may comprise abrasive particles (not shown in this view). The abrasive particles comprise ceramics, cured polymers, process resistant metals, oxides thereof and combinations thereof. In one embodiment, the abrasive particles are chosen to exhibit a hardness less than or equal to copper, to exhibit a hardness greater than copper, or a plurality of abrasive particles having a combination of differing hardnesses thereof. In one embodiment, the abrasive particles range in size from about 0.2 microns to about 1.0 microns.

Conventional bearings, rotary unions and slip rings, collectively referred to as rotary coupler 276, are provided such that electrical, mechanical, fluid, pneumatic, control signals and connections may be coupled between the base 108 and the rotating platen assembly 230 through a hollow drive shaft 212. Alternatively, the slip rings may be a magnetic slip ring, described in U.S. patent application Ser. No. 11/034,350 (Atty. Dock. No. APPM/9331), filed Jan. 11, 2005 and entitled “PLATEN ASSEMBLY UTILIZING MAGNETIC SLIP RING,” which is hereby incorporated by reference. The ECMP station 102 may also be coupled to a vacuum source 246 that provides a low partial pressure to the platen assembly 230 or other parts of the ECMP station 102. The platen assembly 230 is typically coupled to a motor 232 that provides the rotational motion to the platen assembly 230. The motor 232 is coupled to the controller 140 that provides a signal for controlling for the rotational speed and direction of the platen assembly 230. The platen assembly 230 is generally fabricated from a rigid material, such as aluminum, and has an upper surface that may be fabricated from the same material, or a rigid plastic. In one embodiment, the upper surface is fabricated from or coated with a dielectric material, such as CPVC. The upper surface may have a circular, rectangular or other plane form and is adapted to support a processing pad assembly 222 thereon.

Optionally, a magnetic element (not shown) may be disposed within the platen assembly 230 and is adapted to urge the processing pad assembly 222 toward the platen assembly 230. The magnetic element is coupled to a power source 244 through the rotary coupler 276 and the magnetic element is magnetically coupled to metallic material disposed in, on, or coupled to the processing pad assembly 222. It is contemplated that the magnetic element may be coupled to the pad assembly 222 such that the pad assembly 222 is attracted to the platen assembly 230. The magnetic attraction between the magnetic element and processing pad assembly 222 pulls the processing pad assembly 222 against the upper surface of the platen assembly 230 such that the processing pad assembly 222 advantageously remains stationary relative to the platen assembly 230 during processing. Uses of magnetic elements to couple a processing pad assembly are disclosed in United States Patent Publication No. 2005/0000801 (AMAT 004100.P11), filed Jun. 30, 2004, entitled “Method and Apparatus for Electrochemical Mechanical Processing,” and incorporated herein by reference to the extent it is not inconsistent with this disclosure. It is also contemplated that the pad assembly 222 may be coupled to the upper surface of the platen assembly 230 by other means, such as adhesives and/or binders, or vacuum ports, and may not use a magnetic element.

An electrolytic fluid (i.e., a liquid, a liquid solution, or a foam) may be provided from an electrolyte source 248 (i.e., a tank or a drum) through appropriate plumbing and controls to nozzle 255 above the process pad assembly 222 on planarizing module 102. Optionally, a plenum (not shown) may be defined in the platen assembly 230 to supply an electrolyte to the pad assembly 222. The electrolyte may be retained on an upper surface of the pad assembly 222, coupled to the platen assembly 230, by a wall 258 disposed about the perimeter of the platen assembly 230. The pad assembly 222 may have a plurality of holes (not shown) formed therethrough in communication with the plenum. A detailed description of an exemplary planarizing assembly that may be used can be found in the description of FIG. 2 in United States Patent Publication No. 2004/0163946 (AMAT 004100.P10), filed Dec. 23, 2003, entitled “Pad Assembly for Electrochemical Mechanical Processing,” incorporated herein by reference to the extent the application is not inconsistent with this disclosure.

The electrode 292 is typically made of a conductive material, such as stainless steel, copper, aluminum, gold, silver and tungsten, among others. The electrode 292 can be a plate-like member or laminate, a plate having multiple apertures formed therethrough, or a plurality of electrode pieces disposed in a permeable membrane or container. For example, the electrode 292 may be a metal foil, a mesh made of metal wire or metal-coated wire, or a laminated metal layer on a polymer film compatible with the electrolyte, such as a polyimide, polyester, flouroethylene, polypropylene, or polyethylene sheet. The electrode 292 may act as a single electrode, or may comprise multiple independent electrode zones isolated from each other. Zoned electrodes are discussed in United States Patent Publication No. 2004/0082289 (AMAT 004100.P8), filed Aug. 15, 2003, entitled “Conductive Polishing Article for Electrochemical Mechanical Polishing,” which is hereby incorporated by reference to the extent it is not inconsistent with this disclosure. The electrode 292 may be solid, impermeable to electrolyte, permeable to electrolyte or perforated, or combinations thereof. In the embodiment depicted in FIG. 2A, the electrode 292 is solid, but may be perforated and configured to allow electrolyte therethrough. The electrode 292 is disposed on the upper surface of the platen assembly 230 and is coupled to the power source 242 through the platen assembly 230. Electrical connections from the electrode 292 and/or the platen assembly 230 may be routed through a hollow drive shaft 212 to provide electrical communication from the electrode 292 to at least one of the power sources 242 or 244.

The electrode 292, subpad 215, and contact layer 208 of the pad assembly 222 may be combined into a unitary assembly by the use of binders, adhesives, bonding, compression molding, or the like. In one embodiment, adhesive is used to attach the electrode 292, subpad 215, and contact layer 208 together. The adhesive generally is a pressure sensitive adhesive or a temperature sensitive adhesive and should be compatible with the process chemistry as well as with the different materials used for the electrode 292, subpad 215, and/or the contact layer 208. The adhesive may have a strong physical and/or chemical bond to the electrode 292, subpad 215, and the contact layer 208. However, selection of the adhesive may also depend upon the form of the electrode 292, subpad 215, and the contact layer 208. The adhesive bonding between the electrode 292, subpad 215, and the contact layer 208 may be increased by the surface morphology of the materials selected to form the pad assembly 222 (i.e., fabrics, screens, and perforations versus solids). For example, if the electrode 292 is fabricated from a screen, mesh, or perforated foil, a weaker adhesive may be selected due to the increased surface area of the electrode 292. It is also contemplated that stainless steel hook and loop or a stainless steel Velcro® connection may be used as the binder between the electrode 292 and the subpad 215 and/or the electrode 292 and the platen assembly 230. The pad assembly 222 is disposed on the upper surface of the platen assembly 230 and may be held there by magnetic attraction, static attraction, vacuum, adhesives, or the like. In one embodiment, adhesive is used to bind the electrode 292 of the pad assembly 222 to the upper surface of the platen assembly 230.

The contact layer 208 may be fabricated from polymeric materials compatible with the process chemistry, examples of which include polyurethane, polycarbonate, fluoropolymers, PTFE, PTFA, polyphenylene sulfide (PPS), or combinations thereof, and other polishing materials used in polishing substrate surfaces. The polymeric materials may be dielectric or, alternatively, conductive. The contact layer 208 may be smooth or patterned to facilitate distribution of the electrolyte over the surface of the pad assembly 222. Patterns may include posts, grooves, cutouts, perforations, channels or other contours in the surface. In one embodiment, the contact layer 208 comprises a plurality of abrasive particles in a polymer matrix, embossed or compression molded to form a plurality of posts 210 spaced apart by a plurality of interstitial areas 205. The posts 210 are arranged in a pattern on the contact layer 208 and may comprise shapes such as rectangles, ovals, circles, or combinations thereof, in any suitable pattern. The pad assembly 222 may further include perforations which extend at least to the electrode 292. At least one of the contact layer 208 and the posts 210 may be connected to the power source 242 by one or more conductive tabs (not shown).

In the case of a rectangular post, any one side may comprise a length from about 170 microns to about 250 microns in one embodiment. In another embodiment, the length of any one side of a rectangular post is greater than 250 microns, such as about 250 microns to about 2 mm. In yet another embodiment, the length of any one side of a rectangular post is between about 2 mm to about 4 mm. In the case of a circular post, the diameter is between about 170 microns to about 250 microns in one embodiment. In another embodiment, the diameter is greater than 250 microns, such as about 250 microns to about 2 mm. In yet another embodiment, the diameter is greater than 2 mm, such as about 2 mm to about 4 mm. The height of the posts 210 may range in size between about 30 microns to about 60 microns in one embodiment. In another embodiment, the height is greater than about 60 microns, such as about 60 microns to about 1 mm. In yet another embodiment, the height may be a suitable height up to and including about 4 mm.

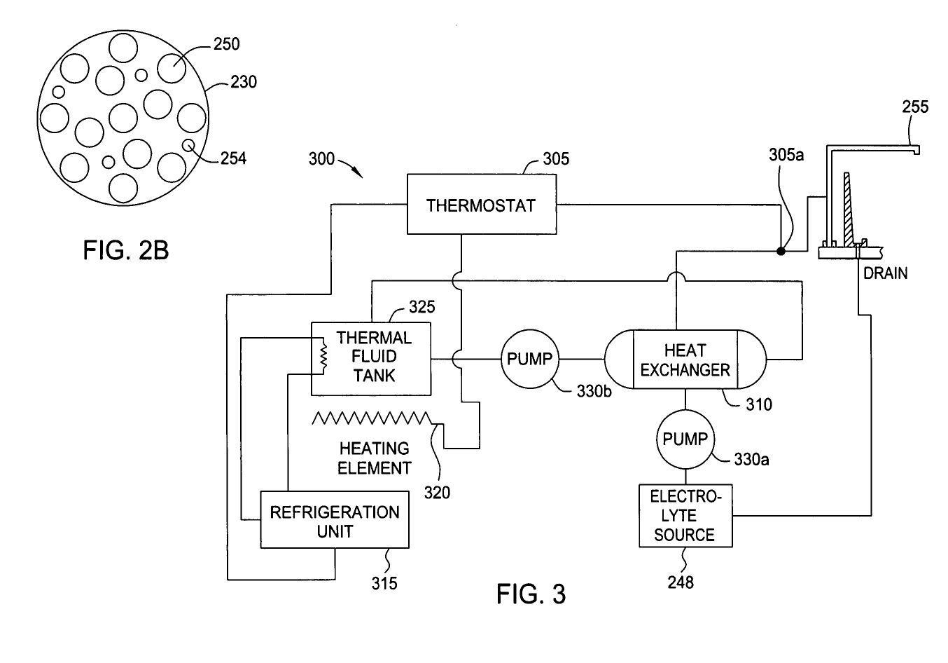

In another embodiment, the pad assembly 222 may include conductive contact elements (not shown) adapted to extend above the contact layer 208. Examples of contact elements that may be used in the pad assembly 222 are described in United States Patent Publication No. 2002/0119286 (AMAT 004100.P1), filed Dec. 27, 2001, entitled “Conductive Polishing Article for Electrochemical Mechanical Polishing,” which is incorporated by reference herein to the extent the application is not inconsistent with this disclosure. A detailed description of a process pad assembly and counterparts that may be used can be found in United States Patent Publication No. 2004/0163946 (AMAT 004100.P10), entitled “Pad Assembly for Electrochemical Mechanical Processing,” which was previously incorporated by reference. Examples of conductive contact elements that may be found in the descriptions of FIGS. 3-13 in United States Patent Publication No. 2005/0000801 (AMAT 004100.P11), filed Jun. 30, 2004, entitled “Method and Apparatus for Electrochemical Mechanical Processing,” which was previously incorporated by reference.

The subpad 215 is typically made of a material softer, or more compliant, than the material of the contact layer 208. The difference in hardness or modulus of elasticity between the contact layer 208 and the subpad 215 may be chosen to produce a desired polishing performance. The subpad 215 may also be compressible. Examples of suitable subpad 215 materials include, but are not limited to, open or closed-cell foamed polymer, elastomers, felt, urethane impregnated felt, plastics, and like materials compatible with the processing chemistries. The contact layer 208 is harder and less compliant than the subpad 215 so the posts 210 balance a suitable force distribution for maintaining sufficient contact with the substrate 114.

The plurality of perforations 218 may be formed in a rectangular pattern, a triangular pattern, or any other uniformly distributed pattern and generally has a percent open area of from about 10% to about 90% (i.e., the area of the holes open to the electrode as a percentage of the total surface area of the polishing layer). The plurality of perforations 218 may be molded in the pad assembly 222 as formed, or the perforations 218 may be formed by, for example, a steel rule die, an ultrasonic knife/punch, or a male/female die punch, among other forming methods. The application or process steps for coating and forming may be determined by the pre-coating topography of the contact layer 208, or the resulting topography desired on the contact layer 208. The perforations 218 may take any shape, such as circles, ovals, squares, rectangles, or combinations thereof. Care should be taken in perforating the pad assembly 222 as any irregularities in the contact surface 125 of the contact layer 208 may cause damage to the substrate 114. The location and open area percentage of the holes 218 in the pad assembly 222 controls the quantity and distribution of electrolyte contacting the electrode 292 and substrate 114 during processing, thereby controlling the rate of removal of material from the feature side 115 of the substrate 114 in a polishing operation, or the rate of deposition in a plating operation.

Temperature Control

FIG. 2B is a plan view of the platen assembly 230 without the pad assembly 222 disposed thereon, according to one embodiment of the present invention. Referring also to FIG. 2A, one or more heating elements, such as infrared (IR) lamps 252, are disposed in respective cavities formed in an upper portion of the platen assembly 230. The IR lamps 252 are in electrical communication, via wiring, with a thermostat 250. The thermostat 250 may be located in the platen assembly 230 (as shown), or may be part of the controller 140 (see FIG. 1). Also disposed in respective cavities formed in an upper portion of the platen assembly 230 are one or more temperature sensors 254. The temperature sensors 254 are also in electrical communication, via wiring (not shown), with the thermostat 250. The thermostat 250 is in electrical communication with one of the power sources 242, 244, via wiring (not shown).

In operation, the thermostat 250 is set to maintain the platen assembly 230 at a predetermined temperature. The thermostat 250 selectively operates the IR lamps 252 to heat the pad assembly 222 and the electrolyte until they reach the predetermined temperature. The temperature sensors 254 provide feedback to the thermostat 250 to facilitate the thermostat 250 in reaching and maintaining the predetermined temperature. The thermostat 250 may selectively operate all of the IR lamps 252 simultaneously or may only operate some of the lamps to account for localized heating due generated by friction during the planarizing process.

In an alternate aspect, one or more IR lamps may instead be attached to the base 108 for maintaining the platen assembly 230 at the predetermined temperature.

FIG. 3 is a diagram for an electrolyte temperature control system 300, according to another embodiment of the present invention. The control system 300 includes pumps 330a,b, the electrolyte source 248, a heat exchanger 310, a heating element 320, a tank 325, a refrigeration unit 315, a thermostat 305, a temperature sensor 305a, thermal fluid, wiring, and fluid conduits. Preferably, the thermal fluid is a liquid, more preferably, water, ethylene glycol, or a mixture thereof. The refrigeration unit will have its own refrigerant; however, since refrigeration units are well known, the unit is not discussed in detail. The pump 330a draws electrolyte from the electrolyte source 248 and forces the electrolyte through a first chamber of the heat exchanger 310 and through the nozzle 255. The pump 330b draws the thermal fluid from the tank 325 and forces the thermal fluid through a second chamber of the heat exchanger 310 and returns the thermal fluid to the tank 325. The heat exchanger 310 transfers heat between the thermal fluid and the electrolyte without mixing the fluids. Both the refrigeration unit 315 and the heating element 320 are in thermal communication with the thermal fluid either directly (i.e. respective coils disposed in the tank 325) or indirectly (i.e. respective coils in contact with an outer surface of the tank 325). The thermostat 305 is in electrical communication with the heating element 320, the refrigeration unit 315, and the temperature sensor 305a. Optionally, a recycle line is provided from the drain to the electrolyte source 248. Optionally, temperature sensors (see FIG. 2A) are also disposed in the platen assembly 230 and electrical communication is provided to the thermostat 305.

In operation, the thermostat 305 is set to maintain the electrolyte at a predetermined temperature. The thermostat 305 selectively operates either the heating element 320 or refrigeration unit 315 to heat/cool the thermal fluid to a certain temperature. The pump 330b is then activated to circulate the thermal fluid. The pump 330a is then activated to supply electrolyte to the nozzle 255. The heat exchanger 310 heats/cools the electrolyte to the predetermined temperature. The temperature sensor 305a provides feedback to the thermostat 305 to facilitate the thermostat 305 in reaching and maintaining the predetermined temperature.

In an alternative aspect of this embodiment, the heating element 320 and the refrigeration unit 315 may be coupled to the electrolyte source 248 instead of the tank 325. This aspect would eliminate the need for the tank 325, the heat exchanger 310, the pump 330b, and the thermal fluid. In this aspect, the temperature sensor would then be coupled to the electrolyte source 248.

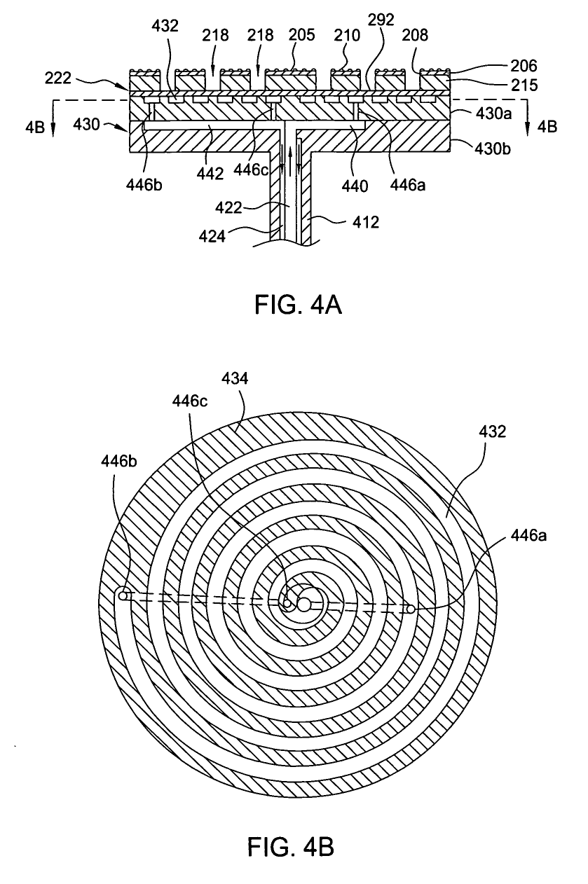

FIG. 4A depicts a sectional view of a platen assembly 430, according to another embodiment of the present invention. FIG. 4B is a sectional view taken along the line 4B-4B of FIG. 4A. An upper portion 430a of the platen assembly 430 has a substantially spiral-shaped temperature adjustment fluid passage 432 formed in an upper surface region thereof. The electrode 292 is disposed on the upper portion 430a so that a seal is formed between a lower surface of the electrode 292 and the upper surface region of the upper portion 430a. The upper portion 430a is similarly disposed on the lower portion 430b. A drive shaft 412 has a flanged end forming a lower portion 430b of the platen assembly 430 and having incoming and outgoing thermal fluid supply passages 440, 442 extending radially and communicating respectively with concentric fluid passages 422, 424. Alternatively, the lower portion 430b of the platen assembly 430 may be a piece separate from the drive shaft 412. The upper portion 430a is provided with three connecting passages 446a,b,c for communicating the spiral passage 432 with the incoming and outgoing supply passages 440, 442 of the flanged end.

Preferably, the incoming connecting passage 446a meets the spiral passage 432 at about the radial mid-point between the center and periphery of the platen assembly 430. That is, the opening of the incoming connecting passage 446a is radially located to correspond with the location of the substrate 114 (see FIG. 2A). Outgoing connecting passage 446b is connected to the outside end of the spiral passage 432, and outgoing connecting passage 446c is connected to the inside end of the spiral passage 432 of the upper portion 430a of the platen assembly 430. In alternative aspects of this embodiment, the connecting passages 446a,b,c may be radially located anywhere along the platen assembly 430 and/or there may be only two connecting passages. Alternatively, the direction of flow through the platen assembly 430 and the drive shaft 412 may be reversed.

An internal thermal fluid passage is thus formed in the platen assembly 430 so that the thermal fluid flows out from the outlet of the inner concentric fluid passage 422 radially along the incoming supply passage 440 in the lower portion 430b, and then flows through the incoming connecting passage 446a of the upper portion 430a to flow into the spiral passage 432. Then, the thermal fluid flows through the spiral passage 432 to branch into inward and outward directions. Inward and outward flows reach the inside and outside ends of the spiral passage 432 and go forward through outgoing connecting passages 446c, 446b, respectively, into the outgoing supply passage 442 to return through the outer concentric passage 424.

Preferably, in the platen assembly 430 of such construction, spiral passage 432 is divided into two sections, and the individual passage is made short so that the circulation time for the thermal medium is shortened. Therefore, the time necessary for starting up the planarizing operation can be shortened, and a quick response in temperature change for controlling operation can be achieved. Also, because the opening of the spiral passage 432 is located proximate the substrate 114, in this embodiment, an advantage is that rapid temperature control at the most critical region of the platen assembly 430 can be achieved efficiently. Alternatively, the spiral passage 432 is not divided.

In addition to the features presented above, the surface temperature of the electrode 230 can be made uniform by maintaining a constant flow rate of thermal fluid per unit area of the upper portion 430a of the platen assembly 430. To achieve this objective, the cross sectional area of the fluid passage may be varied on the outside passage (draining through 446b) and on the inside passage (draining through 446c) of the temperature adjustment passage 432 so as to achieve a constant flow rate in each case. It is also possible to adjust the flow rates by providing a suitable flow adjusting valve in the outgoing connecting passages 446b and 446c so as to produce a constant flow rate per unit area of the upper portion 430a.

Preferably, the upper portion 430a of the platen assembly 430 is made from a polymer so as to provide thermal insulation to prevent heat transfer between the upper portion 430a and the outside environment. Further, the lower portion 430b and the drive shaft 412 may be covered with a coating of insulating material. This facilitates temperature control of the electrode 292, so that thermal response time lag is decreased to achieve even more improved temperature control in the electrode 292. If the lower portion 430b is a separate piece, it may instead be made from a polymer.

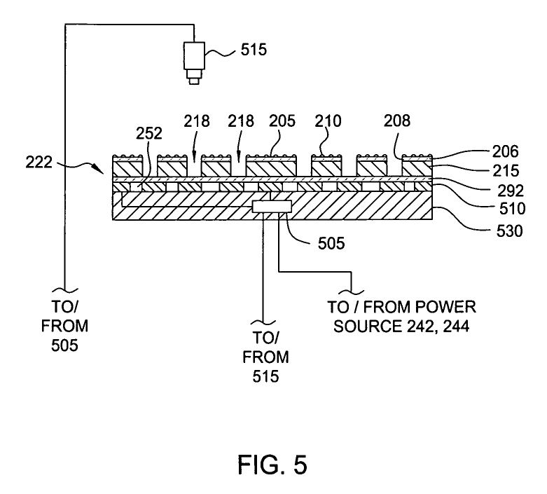

Preferably, the thermal fluid is a liquid, more preferably, water, ethylene glycol, or a mixture thereof. The thermal fluid may be used to heat or cool the electrode 292 so as to maintain the electrode 292 at a predetermined temperature. A system, similar to the one illustrated in FIG. 3, may be used to provide the thermal fluid at a controlled temperature. One or more temperature sensors may be disposed in the upper portion 430a of the platen assembly 430. Alternatively, a temperature sensor (see FIG. 5) may be used to monitor the temperature of the electrolyte.

FIG. 5 depicts a sectional view of a platen assembly 530, according to another embodiment of the present invention. The planarizing surface is heated to a selected temperature with an electrical heating element 510, preferably a substantially spiral-shaped inductive coil, is disposed between the electrode 292 and the platen assembly 530. Alternatively, the heating element 510 may be a plurality of substantially circular concentric inductive coils. Alternatively, the coil(s) 510 may de disposed in the platen assembly 530. The electrode 292 heats up when electrical current is passed through the heating element 510, which in turn, heats the electrolyte and the rest of the pad assembly 222. The heating element 510 is electrically coupled to a thermostat 505 with wiring. A temperature sensor 515, for example, an infrared sensor that directly measures the temperature of the contact surface 125 (see FIG. 1), or other sensing devices known in the art, is also electrically coupled with wiring to a thermostat 505. The temperature sensor 515 may be supported (not shown) from the base 108 (see FIG. 2A). The thermostat 505 is in turn coupled to one of the power sources 242, 244 (see FIG. 2A) to automatically control power to the heating element 510 and establish the desired temperature at the contact surface 125 based on feedback received from the temperature sensors 515. The thermostat 505 may be located in the platen assembly 530 (as shown), or may be part of the controller 140 (see FIG. 1). Alternatively, an operator may monitor the output of the temperature sensor 515 and manually control the temperature of the contact surface 125 to be within a predetermined range.

Similar to the embodiment discussed with FIG. 4A, the platen assembly 530 may be made from a polymer or coated with an insulating coating to prevent heat from escaping to the surrounding environment.

Temperature control of the pad assembly 222 and/or the electrolyte is a low cost and simple way to improve the ECMP process. For example, preliminary testing has shown enhancement in removal rate and substrate surface finish. For example, an increase in process temperature of 10 degrees Celsius (relative to room temperature) has demonstrated an 80%-120% increase in removal rate. It is expected that temperature increases above 10 degrees Celsius may further improve these results. It is also believed that substrate defects may be improved with temperature control.

Other embodiments of the present invention may include a combination of some of the elements from above described embodiments. While the foregoing is directed to embodiments of the present invention, other and further embodiments of the invention may be devised without departing from the basic scope thereof, and the scope thereof is determined by the claims that follow.

1. An apparatus for polishing a substrate, comprising:
a platen assembly having a support surface, the platen assembly disposed on a stationary base so that the platen assembly may rotate relative to the base;
a pad assembly disposed on the support surface of the platen assembly and comprising:
an electrode electrically coupled to a power source; and
an abrasive pad electrically coupled to the power source; and
a control system for heating or cooling the pad assembly.

2. The apparatus of claim 1, wherein the control system comprises a heating element disposed in or proximate to the platen assembly.

3. The apparatus of claim 2, wherein the heating element comprises an infrared lamp disposed in the platen assembly.

4. The apparatus of claim 2, wherein the heating element comprises an infrared lamp attached to the base.

5. The apparatus of claim 2, wherein the control system further comprises a temperature sensor disposed in the platen assembly.

6. The apparatus of claim 2, wherein the heating element comprises an inductive coil disposed between the pad assembly and the platen assembly.

7. The apparatus of claim 6, wherein the coil is substantially spiral shaped.

8. The apparatus of claim 6, wherein the coil is substantially circular and the system further comprises a second substantially circular coil concentrically disposed relative to the coil.

9. The apparatus of claim 6, wherein the control system further comprises a temperature sensor fixed to the base and in visual communication with an upper surface of the pad assembly.

10. The apparatus of claim 1, wherein the control system comprises:
an electrolyte tank;
a first pump in fluid communication with the electrolyte tank;
a heat exchanger having a first chamber and a second chamber, the first chamber in fluid communication with the electrolyte tank and the second chamber in fluid communication with a thermal fluid tank;
the thermal fluid tank;
a second pump in fluid communication with the thermal fluid tank; and
a heating element in thermal communication with the thermal fluid tank.

11. The apparatus of claim 10, wherein the control system further comprises:
a refrigeration unit in thermal communication with the thermal fluid tank.

12. The apparatus of claim 10, wherein the control system further comprises:
a temperature sensor in thermal communication with an outlet of the first chamber; and
a thermostat in electrical communication with the temperature sensor and the heating element.

13. The apparatus of claim 1, wherein the control system comprises:
an electrolyte tank;
a heating element in thermal communication with the electrolyte tank; and
a pump in fluid communication with the electrolyte tank.

14. The apparatus of claim 13, wherein the control system further comprises:
a refrigeration unit in thermal communication with the electrolyte tank.

15. The apparatus of claim 13, wherein the control system further comprises:
a temperature sensor in thermal communication with the electrolyte tank; and
a thermostat in electrical communication with the temperature sensor and the heating element.

16. The apparatus of claim 1, wherein:
the control system comprises a fluid channel formed through an upper surface of the platen assembly, and
a seal is formed between the electrode and the upper surface of the platen assembly.

17. The apparatus of claim 16, wherein the control system further comprises:
a thermal fluid tank in fluid communication with the fluid channel;
a heating element in thermal communication with the thermal fluid tank; and
a pump in fluid communication with the thermal fluid tank and the fluid channel.

18. The apparatus of claim 17, wherein the control system further comprises:
a refrigeration unit in thermal communication with the thermal fluid tank.

19. The apparatus of claim 17, wherein the control system further comprises:
a temperature sensor in thermal communication with the thermal fluid tank; and
a thermostat in electrical communication with the temperature sensor and the heating element.

20. The apparatus of claim 16, wherein the fluid passage is substantially spiral shaped.

21. The apparatus of claim 16, wherein the platen assembly is substantially made from a polymer.

22. A method for polishing a substrate, comprising:
rotating a platen assembly, the platen assembly having a pad assembly disposed thereon, the pad assembly comprising an electrode and an abrasive pad;
creating an electrical bias between the electrode and the pad;
heating or cooling the pad assembly or an electrolyte fluid;
supplying the electrolyte fluid to the pad assembly;
rotating the substrate; and
lowering the substrate into contact with the pad assembly.

23. The method of claim 22, wherein an infrared lamp is disposed in the platen assembly and the act of heating or cooling comprises operating the lamp to heat the pad assembly.

24. The method of claim 22, wherein the platen assembly rotates relative to a base, an infrared lamp is attached to the base, and the act of heating or cooling comprises operating the lamp to heat the pad assembly or the electrolyte fluid.

25. The method of claim 22, wherein an inductive coil is disposed between the electrode and the platen assembly and the act of heating or cooling comprises operating the coil to heat the pad assembly.

26. The method of claim 22, wherein a fluid channel is formed in an upper surface of the platen assembly and the act of heating or cooling comprises circulating a heated or cooled thermal fluid through the fluid channel.

27. The method of claim 22, wherein the act of heating or cooling comprises heating or cooling the electrolyte fluid.

28. The method of claim 22, wherein the act of heating or cooling comprises heating the pad assembly or the electrolyte fluid to a temperature of at least 10 degrees Celsius above room temperature.
